(19) United States
(12) Patent Application Publication
(10) Pub. No.: US 2006/0052572 A1
(43) Pub. Date: Mar. 9, 2006

(54) Metal acetylacetonates as transesterification catalysts

(76) Inventor: Steffen Hofacker, Odenthal (DE)

Correspondence Address: BAYER MATERIAL SCIENCE LLC, 100 BAYER ROAD, PITTSBURGH, PA, 15205, US

(21) Appl. No.: 11/214,995

(22) Filed: Aug. 30, 2005

(30) Foreign Application Priority Data
Sep. 4, 2004 (DE) 102004042843.3

(51) Int. Cl. C08G 18/00

(52) U.S. Cl. 528/44

(57) ABSTRACT

The present invention relates to a process for preparing oligocarbonate polyols having a number average molecular weight of 500 to 5000 g/mol by reacting organic carbonates and aliphatic polyols in the presence of a metal acetylacetonate catalyst based on a metal which has an atomic number in the PTE of 39, 57, 59 to 69 or 71. The present invention also relates to the oligocarbonate polyols obtained by this process.

### BACKGROUND OF THE INVENTION

1. Field of the Invention

The present invention relates to the use of metal acetylacetonates based on metals which have the atomic numbers, in Mendeleev's periodic table of the elements (PTE), of 39, 57, 59 to 69 or 71 as a catalyst for preparing aliphatic oligocarbonate polyols by transesterifying organic carbonates with aliphatic polyols.

2. Description of Related Art

Oligocarbonate polyols are important precursors, for example, in the production of plastics, coatings and adhesives. They may be reacted with isocyanates, epoxides, (cyclic) esters, acids or acid anhydrides (DE-A 1 955 902). They may be prepared from aliphatic polyols by reaction with phosgene (for example DE-A 1 595 446), bischlorocarbonic esters (for example DE-A 857 948), diaryl carbonates (for example DE-A 101 255 57), cyclic carbonates (for example DE-A 2 523 352) or dialkyl carbonates (for example WO 2003/002630).

It is known that, when aryl carbonates such as diphenyl carbonate are reacted with aliphatic polyols such as 1,6-hexanediol, a sufficient reaction conversion can be achieved by shifting the reaction equilibrium merely by removing the alcoholic compound (e.g. phenol) which is released (for example EP-A 0 533 275).

When, alkyl carbonates (e.g. dimethyl carbonate) are used, transesterification catalysts are also frequently used, for example alkali metals or alkaline earth metals and their oxides, alkoxides, carbonates, borates or salts of organic acids (for example WO 2003/002630).

In addition, preference is given to using tin or organotin compounds such as bis(tributyltin) oxide, dibutyltin dilaurate or dibutyltin oxide (DE-A 2 523 352), and also compounds of titanium such as titanium tetrabutoxide, titanium tetraisopropoxide or titanium dioxide, as transesterification catalysts (for example EP-B 0 343 572, WO 2003/002630).

The prior art transesterification catalysts for the preparation of aliphatic oligocarbonate polyols by the reaction of alkyl carbonates with aliphatic polyols do, though, have some disadvantages. Recently, organotin compounds have been recognized as potential carcinogens to humans. They are thus undesired constituents which also remain in subsequent products of the oligocarbonate polyols when the previously preferred compounds, such as bis(tributyltin) oxide, dibutyltin oxide or dibutyltin laurate, are used as catalysts.

When strong bases such as alkali metals or alkaline earth metals or their alkoxides are used, it is necessary, on completion of oligomerization, to neutralize the products in an additional process step. When, in contrast, Ti compounds are used as catalysts, undesired discoloration (yellowing) can occur during storage of the resulting product, which is caused by factors including the presence of Ti(III) compounds in addition to Ti(IV) compounds and/or by the tendency of titanium to form complexes.

In addition to this undesired discoloration, titanium-containing catalysts have a high activity toward isocyanate-containing compounds in the further reaction of the hydroxyl-terminated oligocarbonates as a polyurethane raw material. This property is particularly marked in the case of reaction of the titanium-catalyzed oligocarbonate polyols with aromatic (poly)isocyanates at elevated temperature, as is the case, for example, in the preparation of cast elastomers or thermoplastic polyurethanes (TPUs). The result of this disadvantage can be so severe that, due to the use of titanium-containing oligocarbonate polyols, the pot life or reaction time of the reaction mixture is shortened to such an extent that use of such oligocarbonate polyols for these fields of application is no longer possible. To avoid this disadvantage, the transesterification catalyst remaining in the product is very substantially inactivated in at least one additional process step after completion of the synthesis.

EP-B 1 091 993 teaches inactivation by the addition of phosphoric acid, while U.S. Pat. No. 4,891,421 also proposes inactivation by hydrolysis of the titanium compound by adding an appropriate amount of water to the product and, on completion of deactivation, removing it again from the product by distillation.

It has also not been possible with the catalysts used to date to lower the reaction temperature, which is typically between 150° C. and 230° C., in order to substantially prevent the formation of by-products such as ethers or vinyl groups, which can form at elevated temperature. As chain terminators for subsequent polymerization reactions, for example in the case of the polyurethane reaction with polyfunctional (poly)isocyanates, these undesired end groups lead to lowering of the network density and thus to poorer product properties (for example solvent or acid resistance).

In addition, oligocarbonate polyols, which have been prepared with the aid of the catalysts known from the prior art, have high contents of ether groups (e.g. methyl ether, hexyl ether, etc.). The presence of these ether groups in the oligocarbonate polyols lead, for example, to insufficient hot air stability of cast elastomers based on such oligocarbonate polyols, since ether bonds in the material are cleaved under these conditions and thus lead to failure of the material.

In the German patent application No. 10321149.7, which was not published as of the priority date of the present application, acetylacetonates of ytterbium are described as effective catalysts for the transesterification of aliphatic oligocarbonate polyols.

It is an object of the present invention to provide suitable catalysts for the transesterification reaction of organic carbonates with aliphatic polyols for the preparation of aliphatic oligocarbonate polyols.

This object has been achieved according to the present invention by using acetylacetonate compounds of the metals having atomic number 39, 57, 59 to 69 or 71 of the PTE as catalysts for the transesterification reaction of organic carbonates with aliphatic polyols.

### SUMMARY OF THE INVENTION

The present invention relates to a process for preparing oligocarbonate polyols having a number average molecular weight of 500 to 5000 g/mol by reacting organic carbonates and aliphatic polyols in the presence of a metal acetylacetonate catalyst based on a metal which has an atomic number in the PTE of 39, 57, 59 to 69 or 71. The present invention also relates to the oligocarbonate polyols obtained by this process.

### DETAILED DESCRIPTION OF THE INVENTION

The acetylacetonate compounds of the metals having the atomic numbers 39, 57, 59 to 69 or 71 of the PTE are preferably the acetylacetonates of yttrium, praseodymium, neodymium, samarium, gadolinium, terbium, dysprosium, holmium, erbium, thulium and/or lutetium, more preferably yttrium, samarium, terbium, dysprosium, holmium and/or erbium.

The metals in the acetylacetonate compounds are preferably present in the +III oxidation state. yttrium(III) acetylacetonate is especially preferred as a catalyst. The acetylacetonates used in accordance with the invention may be used in the process either as a solid or in solution, for example dissolved in one of the reactants. The concentration of the catalyst is 0.01 ppm to 10000 ppm, preferably 0.1 ppm to 5000 ppm and more preferably 0.1 ppm to 1000 ppm, based on the total weight of reactants used. In the process according to the invention, either a single metal acetylacetonate or a mixture of metal acetylacetonates may be used as the catalyst.

The reaction temperature for the transesterification reaction is preferably 40° C. to 250° C., more preferably 60° C. to 230° C. and most preferably 80° C. to 210° C. The transesterification reaction may be carried out either under atmospheric pressure or under reduced or elevated pressure of 10⁻³ to 10³ bar. The ratio of organic carbonate to aliphatic polyols is determined by the desired molecular weight of the carbonate polyol to be achieved of 500 to 5000 g/mol.

Suitable organic carbonates include aryl, alkyl or alkylene carbonates which are known for their simple preparation and good availability. Examples include diphenyl carbonate (DPC), dimethyl carbonate (DMC), diethyl carbonate (DEC) and ethylene carbonate. Preferred are diphenyl carbonate, dimethyl carbonate or diethyl carbonate, especially diphenyl carbonate or dimethyl carbonate.

The reaction partners for the organic carbonates include aliphatic alcohols having 2 to 100 carbon atoms, which may be linear, cyclic, branched, unbranched, saturated or unsaturated, and have an OH functionality of ≧2 (primary, secondary or tertiary). The hydroxyl functionality of these polyols is preferably at most 10, more preferably at most 6 and most preferably at most 3.

Examples include ethylene glycol, 1,3-propylene glycol, 1,3-butanediol, 1,4-butanediol, 1,5-pentanediol, 1,6-hexanediol, 2-ethylhexanediol, 3-methyl-1,5-pentanediol, cyclohexanedimethanol, trimethylolpropane, pentaerythritol, dimeric diol and diethylene glycol.

It is also possible in accordance with the invention to use polyols which are obtained by a ring-opening reaction of a lactone or epoxide with an aliphatic alcohol (linear, cyclic, branched, unbranched, saturated or unsaturated) having an OH functionality of ≧2 (primary, secondary or tertiary), for example the adduct of ε-caprolactone and 1,6-hexanediol or ε-caprolactone and trimethylolpropane, and mixtures thereof.

Finally, the reactants used may also be mixtures of the previously mentioned polyols.

Preference is given to aliphatic or cycloaliphatic, branched or unbranched, primary or secondary polyols having an OH functionality of ≧2. Particular preference is given to aliphatic, branched or unbranched, primary polyols having a functionality of ≧2.

When the above-described acetylacetonates are used, it is possible to dispense with a final deactivation of the transesterification catalysts, for example, by adding masking agents such as phosphoric acid, dibutyl phosphate or oxalic acid, or precipitation reagents such as water. The resulting metal acetylacetonate-containing oligocarbonate polyols are thus suitable without further treatment as raw materials, for example for polyurethane preparation.

The oligocarbonate polyols according to the invention have a lower content of ether groups than the oligocarbonate diols which have been prepared with prior art catalysts. This has a direct influence on the properties of the subsequent products prepared from them, such as NCO-terminated prepolymers. The oligocarbonate polyols according to the invention exhibit better storage stability than the prepolymers prepared with the prior art oligocarbonate diols. In addition, the cast elastomers produced from these oligocarbonate diols have a higher hot air stability.

It has additionally been found that metal acetylacetonates based on metals which have the atomic numbers in the PTE of 39, 57, 59 to 69 or 71 may also be used advantageously for the catalysis of other esterification or transesterification reactions, for example for the preparation of polyesters or polyacrylates. The catalysts may then remain in the product during further reactions, since they do not adversely affect the reaction of the polyols with polyisocyanates.

The invention is further illustrated but is not intended to be limited by the following examples in which all parts and percentages are by weight unless otherwise specified.

### EXAMPLES

The NCO content described in the examples which follow were determined in a triple determination according to DIN EN ISO 11909. The viscosities were determined according to DIN EN ISO 3219 with the aid of the RotoVisco® instrument from Haake, Karlsruhe, Germany.

The contents listed in Examples 2 and 3 of compounds which, unlike the theoretical hydroxyl-functional target compound, bear terminal methyl ether groups were determined by ¹H NMR analysis and the integral evaluation of the corresponding signals. The contents reported may be regarded as fractions of the compound listed based on 1 mole of the theoretical target compound having two terminal hydroxyl groups.

### Example 1

In a 20 ml rolled-flange glass vessel, dimethyl carbonate (3.06 g) and 1-hexanol (6.94 g) in a molar ratio of 1:2 were mixed together with in each case a constant amount (5.7-10⁻⁶ mol) of a catalyst (see Table 1) and sealed with a septum made of natural rubber including gas outlet. When the catalyst used was in the solid state at room temperature, it was initially dissolved in one of the reactants. The reaction mixture is heated with stirring to 80° C. for six hours. After cooling to room temperature, the product spectrum was analyzed by means of gas chromatography, if appropriate coupled to mass spectrometry analyses. The contents of reaction products, specifically of methyl hexyl carbonate and dihexyl carbonate, which can be detected as a measure of the activity of the transesterification catalyst used, were quantified by integral evaluation of the particular gas chromatograms. The results of these activity investigations are listed in Table 1.

TABLE 1
Catalysts used and contents of reaction products

| | | Content of | Content of | |
|---|---|---|---|---|
| | | methyl hexyl | dihexyl | Sum of the |
| | | carbonate | carbonate | contents |
| No. | Catalyst | [area %] | [area %] | [area %] |
| 1 | no catalyst | 4.0 | 0.1 | 4.1 |
| 2 | Dibutyltin oxide | 5.1 | 0.2 | 5.3 |
| 3 | Dibutyltin laurate | 3.4 | 0.1 | 3.5 |
| 4 | Bis(tributyltin) oxide | 3.7 | 0.0 | 3.7 |
| 5 | Titanium | 1.9 | 0.0 | 1.9 |
| | tetraisopropoxide | | | |
| 6 | Magnesium carbonate | 2.1 | 0.1 | 2.2 |
| 7 | Scandium(III) | 6.0 | 0.3 | 6.3 |
| | acetylacetonate | | | |
| 8 | Yttrium(III) | 29.4 | 13.5 | 42.9 |
| | acetylacetonate | | | |
| 9 | Lanthanum(III) | 13.7 | 1.2 | 14.9 |
| | acetylacetonate | | | |
| 10 | Cerium(III) | 0.8 | 0.0 | 0.8 |
| | acetylacetonate | | | |
| 11 | Praseodymium(III) | 23.3 | 4.7 | 28.0 |
| | acetylacetonate | | | |
| 12 | Neodymium(III) | 19.5 | 2.9 | 22.4 |
| | acetylacetonate | | | |
| 13 | Samarium(III) | 27.4 | 8.7 | 36.1 |
| | acetylacetonate | | | |
| 14 | Gadolinium(III) | 25.9 | 6.4 | 32.3 |
| | acetylacetonate | | | |
| 15 | Terbium(III) | 27.6 | 8.5 | 36.1 |
| | acetylacetonate | | | |
| 16 | Dysprosium(III) | 27.5 | 7.9 | 35.4 |
| | acetylacetonate | | | |
| 17 | Holmium(III) | 28.5 | 8.2 | 36.7 |
| | acetylacetonate | | | |
| 18 | Erbium(III) | 28.3 | 9.0 | 37.3 |
| | acetylacetonate | | | |
| 19 | Thulium(III) | 24.8 | 6.5 | 31.3 |
| | acetylacetonate | | | |
| 20 | Lutetium(III) | 26.9 | 7.3 | 34.2 |
| | acetylacetonate | | | |

As is clear from the above experiments, the metal acetylacetonates to be used in accordance with the invention are very suitable as transesterification catalysts for the preparation of oligocarbonate polyols. Experiments No. 7 and 10 also show that not all transition metal acetylacetonates are suitable for the catalysis of the transesterification reaction.

### Example 2

Preparation of an Aliphatic Oligocarbonate Diol Using Yttrium(III) Acetylacetonate

A 5 l pressure reactor with distillation attachment, stirrer and receiver was initially charged with 1759 g of 1,6-hexanediol together with 0.02 g of yttrium(III) acetylacetonate. A nitrogen pressure of 2 bar was applied and the mixture was heated to 160° C. Afterwards, 1245.5 g of dimethyl carbonate were metered in within 3 h, during which the pressure rose simultaneously to 3.9 bar. Afterwards, the reaction temperature was increased to 185° C. and the reaction mixture was stirred for 1 h. Finally, a further 1245.5 g of dimethyl carbonate were metered in within 3 h, during which the pressure rose to 7.5 bar. On completion of the addition, the mixture was stirred for a further 2 h, during which the pressure rose to 8.2 bar. Over the entire transesterification process, the passage to the still and receiver was always open, so that methanol which formed was able to be distilled off in admixture with dimethyl carbonate. Finally, the reaction mixture was decompressed to standard pressure within 15 minutes, the temperature was lowered to 150° C. and the mixture was distilled further at this temperature for a further one hour. Afterwards, excess dimethyl carbonate and methanol were removed and the terminal OH groups were decapped (activated) by lowering the pressure to 10 mbar. After two hours, the temperature was finally increased to 180° C. within 1 h and maintained for a further 4 h. The resulting oligocarbonate diol had an OH number of 5 mg KOH/g.

The reaction mixture was aerated, admixed with 185 g of 1,6-hexanediol and heated to 180° C. under standard pressure for 6 h. Subsequently, the pressure was lowered to 10 mbar at 180° C. for 6 h.

After aeration and cooling of the reaction mixture to room temperature, a colorless, waxlike oligocarbonate diol having the following characteristic data was obtained: Mₙ=2000 g/mol; OH number=56.5 mg KOH/g; methyl ether content: <0.1 mol %; viscosity: 2800 mPas at 75° C.

### Example 3 (Comparison)

Preparation of an Aliphatic Oligocarbonate Diol Using a Known, Prior Art Catalyst

A 5 l pressure reactor with distillation attachment, stirrer and receiver was initially charged with 1759 g of 1,6-hexanediol together with 0.02 g of titanium tetraisopropoxide. A nitrogen pressure of 2 bar was applied and the mixture was heated to 160° C. Afterwards, 622.75 g of dimethyl carbonate were metered in within 1 h, during which the pressure rose simultaneously to 3.9 bar. Afterwards, the reaction temperature was increased to 180° C. and a further 622.75 g of dimethyl carbonate were added within 1 h. Finally, a further 1245.5 g of dimethyl carbonate were metered in at 185° C. within 2 h, during which the pressure rose to 7.5 bar. On completion of the addition, the mixture was stirred for a further one hour at this temperature. Over the entire transesterification process, the passage to the still and receiver was always open, so that methanol which formed was able to be distilled off in admixture with dimethyl carbonate. Finally, the reaction mixture was decompressed to standard pressure within 15 minutes, the temperature was lowered to 160° C. and the mixture was distilled further at this temperature for an additional one hour. Afterwards, excess methanol and dimethyl carbonate were removed and the terminal OH groups were decapped (activated) by lowering the pressure to 15 mbar. After distillation under these conditions for a further 4 h, the reaction mixture was aerated. The resulting oligocarbonate diol had an OH number of 116 mg KOH/g. The reaction mixture was then admixed with 60 g of dimethyl carbonate and heated to 185° C. at a pressure of 2.6 bar for 6 h.

Subsequently, the pressure was lowered to 15 mbar at 185° C. for 8 h. After aeration and finishing of the reaction product with 0.04 g of dibutyl phosphate as a catalyst deactivator and cooling of the reaction mixture to room temperature, a colorless, waxlike oligocarbonate diol having the following characteristic data was obtained: Mₙ=2000 g/mol; OH number=56.5 mg KOH/g; methyl ether content: 3.8 mol %; viscosity: 2600 mPas at 75° C.

The ether content of the oligocarbonate diol obtained in Example 2 is distinctly lower than that of the oligocarbonate diol obtained in Example 3. This has a direct influence on the hot air stability of cast elastomers produced from these polyols.

### Example 4

Use of the Aliphatic Oligocarbonate Diol from Example 2 as a Raw Material for Preparing a Polyurethane Prepolymer

A 250 ml three-necked flask with stirrer and reflux condenser was initially charged at 80° C. with 50.24 g of diphenylmethane 4,4′-diisocyanate. 99.76 g of the aliphatic oligocarbonate diol from Example 2, heated to 80° C., were then added slowly under a nitrogen atmosphere (an equivalent ratio of isocyanate groups to hydroxyl groups of 1.00:0.25). On completion of the addition, the mixture was stirred for a further 30 minutes.

A liquid highly viscous polyurethane prepolymer having the following characteristic data was obtained: NCO content: 8.50% by weight; viscosity: 6600 mPas @ 70° C.

Subsequently, the prepolymer was stored at 80° C. for a further 72 h and then the viscosity and the NCO content were checked. After storage, a liquid product having the following characteristic data was obtained: NCO content: 8.40% by weight; viscosity: 7000 mPas @ 70° C. (corresponds to a viscosity increase of 6.1%).

### Example 5 (Comparison)

Use of the Aliphatic Oligocarbonate Diol from Example 3 as a Raw Material for Preparing a Polyurethane Prepolymer

A 250 ml three-necked flask with stirrer and reflux condenser was initially charged at 80° C. with 50.24 g of diphenylmethane 4,4′-diisocyanate. 99.76 g of aliphatic oligocarbonate diol from Example 3, heated to 80° C., were then added slowly under a nitrogen atmosphere (an equivalent ratio of isocyanate groups to hydroxyl groups of 1.00:0.25). On completion of the addition, the mixture was stirred for a further 30 minutes.

A liquid highly viscous polyurethane prepolymer having the following characteristic data was obtained: NCO content: 8.5% by weight; viscosity: 5700 mPas @ 70° C.

Subsequently, the prepolymer was stored at 80° C. for a further 72 h and then the viscosity and the NCO content were checked. After storage, a solid (gelled) product was obtained.

As is evident from the comparison of the viscosities of Examples 4 and 5, the viscosity of the prepolymer from Example 5 increased during storage so greatly that it gelled, while the increase in the viscosity in Example 4 at 6.4% is well below the critical level of 20%.

It is apparent that aliphatic oligocarbonate polyols, which have been prepared using one or more inventive catalysts, have a distinctly lower and thus more advantageous activity with regard to the reaction with (poly)isocyanates to form (poly)urethanes when compared to those, which have been prepared with the aid of known, prior art catalysts, even though these known catalysts have additionally been “inactivated”.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing an oligocarbonate polyol having a number-average molecular weight of 500 to 5000 g/mol which comprises reacting an organic carbonate and an aliphatic polyol in the presence of a catalyst comprising a metal acetylacetonate based on a metal which has an atomic number in the PTE of 39, 57, 59 to 69 or 71.

2. The process of claim 1 wherein the catalyst comprises a metal acetylacetonate based on yttrium, samarium, terbium, dysprosium, holmium and/or erbium.

3. The process of claim 1 wherein the catalyst comprises yttrium(III) acetylacetonate.

4. The process of claim 1 wherein the process is carried out at a temperature of 80 to 210° C.

5. The process of claim 1 wherein said aliphatic polyol comprises an aliphatic, branched or unbranched, primary polyol having an OH functionality of ≧2.

6. The process of claim 2 wherein said aliphatic polyol comprises an aliphatic, branched or unbranched, primary polyol having an OH functionality of ≧2.

7. The process of claim 3 wherein said aliphatic polyol comprises an aliphatic, branched or unbranched, primary polyol having an OH functionality of ≧2.

8. The process of claim 1 wherein said organic carbonate comprises diphenyl carbonate or dimethyl carbonate.

9. The process of claim 2 wherein said organic carbonate comprises diphenyl carbonate or dimethyl carbonate.

10. The process of claim 3 wherein said organic carbonate comprises diphenyl carbonate or dimethyl carbonate.

11. The process of claim 5 wherein said organic carbonate comprises diphenyl carbonate or dimethyl carbonate.

12. The process of claim 6 wherein said organic carbonate comprises diphenyl carbonate or dimethyl carbonate.

13. The process of claim 7 wherein said organic carbonate comprises diphenyl carbonate or dimethyl carbonate.

14. An oligocarbonate polyol having a number-average molecular weight of 500 to 5000 g/mol which is prepared by a process comprising reacting an organic carbonate and an aliphatic polyol in the presence of a catalyst comprising a metal acetylacetonate based on a metal which has an atomic number in the PTE of 39, 57, 59 to 69 or 71.

15. The oligocarbonate polyol of claim 14 wherein the catalyst comprises a metal acetylacetonate based on yttrium, samarium, terbium, dysprosium, holmium and/or erbium.

16. The oligocarbonate polyol of claim 14 wherein the catalyst comprises yttrium(III) acetylacetonate.

17. The oligocarbonate polyol of claim 14 wherein said aliphatic polyol comprises an aliphatic, branched or unbranched, primary polyol having an OH functionality of ≧2.

18. The oligocarbonate polyol of claim 14 wherein said organic carbonate comprises diphenyl carbonate or dimethyl carbonate.

19. The oligocarbonate polyol of claim 17 wherein said organic carbonate comprises diphenyl carbonate or dimethyl carbonate.

20. A polyurethane prepared from the oligocarbonate polyol of claim 14.
